(19) United States
(12) Patent Application Publication
(10) Pub. No.: US 2016/0206491 A1
(43) Pub. Date: Jul. 21, 2016

(54) METHOD AND DEVICE FOR TRANSPORTING PATIENTS BETWEEN TARGET MODALITIES USING ROLLERS

(71) Applicant: QFIX SYSTEMS, LLC, Avondale, PA (US)

(72) Inventors: Daniel D. COPPENS, Avondale, PA (US); David R. RABENO, Avondale, PA (US); Richard J. HERRSCHAFT, West Chester, PA (US); John R. CAPONE, West Chester, PA (US)

(73) Assignee: QFIX SYSTEMS, LLC, Avondale, PA (US)

(21) Appl. No.: 14/911,579

(22) PCT Filed: Aug. 13, 2014
(86) PCT No.: PCT/US14/50841

§ 371 Date: Feb. 11, 2016

Related U.S. Application Data
(60) Provisional application No. 61/865,539, filed on Aug. 13, 2013.

(51) Int. Cl. A61G 7/10

(52) U.S. Cl. CPC A61G 7/1034; A61G 7/1026; A61G 7/103

(57) ABSTRACT

A system for transporting a patient between modalities. The system includes a treatment couch having a couch top, a trolley having a stationary surface, and a patient transfer device having a surface configured to support a patient. The system also include at least one roller positioned to facilitate movement of the patient transfer device with respect to the stationary surface of the trolley, providing a low friction interface between the patient transfer device and the stationary surface of the trolley as the patient transfer device is moved, relative to the stationary surface of the trolley, between the stationary surface of the trolley and the couch top of the treatment couch.

### CROSS REFERENCE TO RELATED APPLICATION

This application relates to Provisional Application No. 61/865,539 (“A Method and Device for Transporting Patients Between Target Modalities Using Rollers”), filed on Aug. 13, 2013, the disclosure of which application is incorporated herein by reference in its entirety for all purposes.

### FIELD OF THE INVENTION

The present invention relates to the transportation of radiation therapy patients from one modality to another.

### BACKGROUND OF THE INVENTION

Radiation therapy is a technique used to treat patients suffering from cancer. An external radiation beam is used to treat the tumor. In order to ensure that the radiation beam is applied to the cancerous cells and to minimize the amount of radiation applied to healthy cells it is imperative that the location of the tumor is known. In order to pinpoint the location of the tumor multiple imaging techniques can be used such as CT, x-ray, or magnetic resonance. After imaging the patient is treated on either a Linear Accelerator (photon treatment) or a proton treatment machine or using brachytherapy. A typical patient will undergo a series of treatments over the course of a few weeks. In order to ensure that the patient is positioned in the same position for each treatment a variety of immobilization devices are often used. The effort required to set up a patient in these devices can often take significant time. This process is typically performed in the treatment room. This is time that the machine is not able to treat the subject or other patients. In addition, it is sometimes required to re-image the patient throughout the course of treatment to verify that the treatment is being applied to the desired location.

In view of the foregoing, there exists a need for more time efficient and safe transferring of patients between modalities for treatment and imaging.

### SUMMARY OF THE INVENTION

Aspects of the invention include a system for transporting a patient between modalities. The system includes a treatment couch having a couch top, a trolley having a stationary surface, and a patient transfer device having a surface configured to support a patient. The system also includes at least one roller positioned to facilitate movement of the patient transfer device with respect to the stationary surface of the trolley, providing a low friction interface between the patient transfer device and the stationary surface of the trolley as the patient transfer device is moved, relative to the stationary surface of the trolley, between the stationary surface of the trolley and the couch top of the treatment couch.

Further aspects of the invention include a patient transfer device configured for transporting a patient between surfaces of modalities. The patient transfer device includes a top surface and a bottom surface, the top surface being configured to support a patient. The patient transfer device also includes at least one roller associated with the bottom surface of the patient transfer device, the at least one roller being positioned to facilitate movement of the patient transfer device with respect to a stationary surface of one modality, thereby providing a reduced friction interface between the patient transfer device and the stationary surface of the one modality as the patient transfer device is moved, relative to the stationary surface of one modality, between the stationary surface of the one modality and a surface of another modality.

Additional aspects of the invention include a method for transporting a patient between modalities. The method includes placing a patient transfer device on a stationary surface of one modality, positioning a patient on a top surface of the patient transfer device, and aligning the stationary surface of the one modality to a surface of another modality. The method also includes transferring the patient transfer device with the patient on the top surface between the stationary surface of the one modality and the surface of the another modality along at least one roller associated with the patient transfer device, the at least one roller facilitating movement of the patient transfer device between the stationary surface of the one modality and the surface of the another modality.

Even further aspects of the invention include a patient transfer system. The patient transport system includes a patient surface, a lower surface, and at least one roller separating or interposed between the patient surface and the lower surface.

Aspects of the invention also include a roller for transferring patients. The roller includes a bottom plate containing a pocket, a top plate containing at least one circular cutout, and at least one circular roller which is encapsulated between the bottom plate and the top place and protrudes through the at least one cut out of the top plate.

### BRIEF DESCRIPTION OF THE DRAWINGS

FIG. 1 illustrates schematically an embodiment of two surfaces separated by spherical rollers;

FIG. 2 illustrates schematically an embodiment of two surfaces separated by elliptical rollers;

FIG. 3 is an isometric view of an embodiment of a patient transfer device with a top surface and rollers;

FIGS. 4A and 4B are isometric views of an embodiment of a patient transfer device with a bottom surface and rollers;

FIG. 5A illustrates an embodiment of a roller including a top plate, bottom plate, and at least one roller;

FIG. 5B is an exploded view of the roller depicted in FIG. 5A;

FIG. 6 illustrates an embodiment of a patient transfer device atop a trolley adjacent to a couch; and

FIG. 7 illustrates an embodiment of a patient transfer device atop a couch.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the scope of the invention. The present invention provides systems, methods, and devices for decreasing the amount of time that is spent setting a patient up inside a treatment room. This time savings allows more treatments to be performed each day. This allows more cancer sufferers to have access to the critical treatment they need. It also allows the hospital or treatment facility to achieve the maximum return on their investment in the treatment facility.

The present invention provides a low friction transfer surface. This allows the patient and immobilization devices to be setup outside the treatment room. They are then transported to the treatment room and transferred to the treatment modality.

When transporting patients from one device or table (target modality) of a hospital to another, it is often desirable to employ a low friction transfer device which consists of rollers. Such a device enables the safe transfer of a patient from one target modality to another. By placing rollers between the patient surface of the patient transfer device and target modality, the patient can be moved easily and safely for both the patient and the hospital staff moving the patient. A desirable low friction transfer device must also work with a variety of imaging and treatment modalities.

One or more rollers can be attached to the bottom surface of a patient transfer device or top surface of the target modality. They can be placed selectively on either surface to maximize imaging area. This allows a very low friction transfer of the patient from a trolley to a target device. The target device may be many different types of equipment, including but not limited to: radiation therapy treatment tables, CT tables, MRI tables, brachytherapy tables, etc. In other words, one example of the use of the system involves transfer to CT and MRI couches (for imaging) as well as treatment couches. There are also systems in which the patient is imaged and treated on the same couch (MRI/Linac), and the present invention can be utilized for such systems as well.

Referring to the figures generally, the invention provides patient transfer devices (such as devices 2, 30, 40 and 66) for transferring patients between modalities in a time-efficient manner. The modalities can include a trolley (such as trolley 60), a stationary surface (such as surfaces 4 and 65), a treatment couch (such as treatment couch 64), and/or a couch top (such as couch top 62).

Generally, a low friction interface is provided between the patient transfer devices and the modalities. For example, rollers (such as rollers 6, 20, 32, 42, and 50) are positioned between the patient transfer device and the modality to facilitate movement of the patient transfer device and the modalities. The rollers may be coupled, embedded, attached, mounted, adhered, and/or otherwise associated with, etc., with the patient transfer device via the bottom surface (such as bottom surfaces 10, 33, and 41) of the patient transfer device and/or the top surface (such as top surfaces 12 and 68, and couch top 62) of the modalities.

The rollers and patient transfer devices may be formed of various materials. For example, the materials may include ceramic-based materials, polymers, metallic-based materials, composite materials, and/or any combination thereof, but equivalent materials are contemplated for use as well.

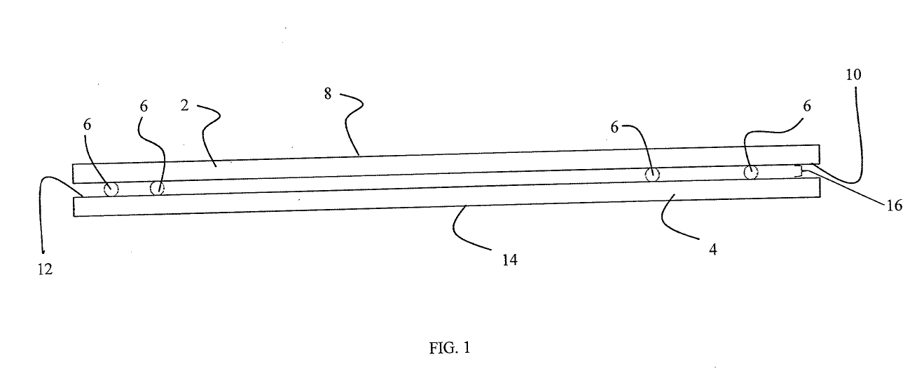

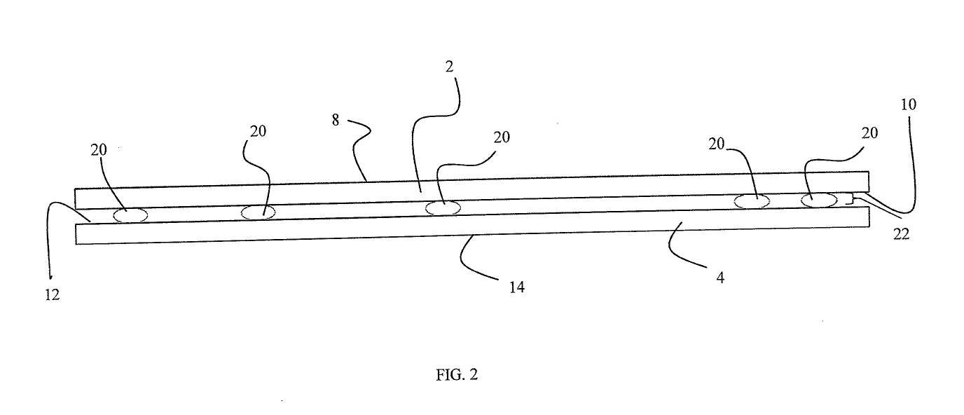

FIGS. 1 and 2 show side views of a patient transfer device 2 above a modality 4. The patient transfer device 2 includes a top surface 8 configured to support a patient and a bottom surface 10. The modality 4 includes a top surface 12 and a bottom surface 14. The top surface 12 of the modality 4 may be a stationary surface that is stationary with respect to movement of the patient transfer device 2. The two surfaces (e.g., the bottom surface 10 and the top surface 12) are separated by a number of spherical rollers 6. These rollers 6 create a low friction interface which allows the patient transfer device to move relative to the stationary surface (e.g., top surface 12 of the modality 4). FIG. 2 shows that the low friction interface can also be created by elliptical rollers 20. Although spherical and elliptical rollers are depicted, various shapes for the rollers are contemplated for use with the disclosed patient transfer systems, such as cylindrical, conical, etc.

As depicted in FIGS. 1 and 2, the rollers 6, 20 are positioned between the patient transfer device 2 and the modality 4. The rollers 6 and 20 may be coupled to the patient transfer device 2 or the modality 4. In one embodiment, the rollers 6 and 20 are coupled to the bottom surface 10 of the patient transfer device 10. In an alternative embodiment, the rollers 6 and 20 are coupled to the top surface 12 of the modality 4. It is contemplated that some rollers may be coupled to the patient transfer device 2 and some rollers may be coupled to the modality 4.

The rollers 6 and 20 are positioned such that a space (e.g., space 16 and space 22) is formed between the bottom surface 10 of the patient transfer device 2 and the top surface 12 of the modality 4. It is preferable to keep the height of the space 16 and 22 minimal. The spaces 16 and 22 create air gaps between the patient transfer device 2 and the modality 4 which can impact treatment delivery and imaging accuracy. In one embodiment, the rollers 6 and 20 protrude from the patient transfer device 2 such that the space 16, 22 is about 1 cm. The spaces 16 and 22 may preferably be less than about 0.5 cm.

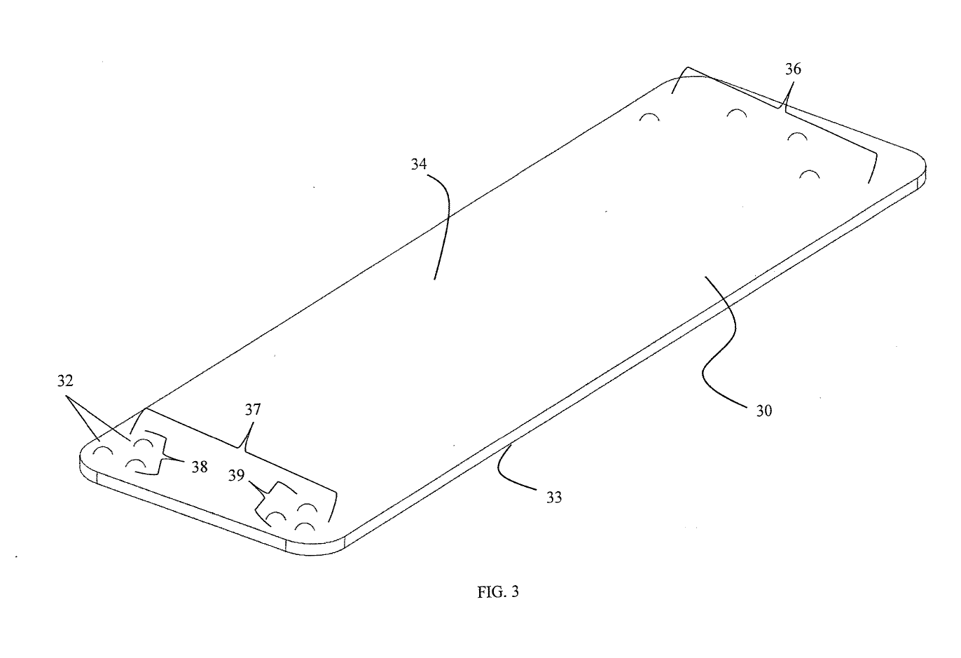

In FIG. 3 a patient transfer device 30 is shown with rollers 32. These rollers 32 can be positioned in such a way that it maximizes the unobstructed treatment area and allows the radiation beam to access the area of interest. The patient transfer device 30 includes a top surface 34 and a bottom surface 33. The rollers 32 are embedded into the patient transfer device 30 from the bottom surface 33, such that the rollers 32 create upward protrusions into the top surface 34 of the patient transfer device 30. As depicted, the rollers 32 are positioned in sets, such that a first set 36 is positioned at one end of the device 30 and a second set 37 is positioned at another end of the device 2. The positioning of the sets 36 and 37 of rollers 32 is such that the rollers 32 are positioned substantially outside the treatment area and/or imaging area of the patient transfer device 2. Each set of rollers 32 may also include groups, such as the left group 38 and the right group 39 of rollers 32 in set 37.

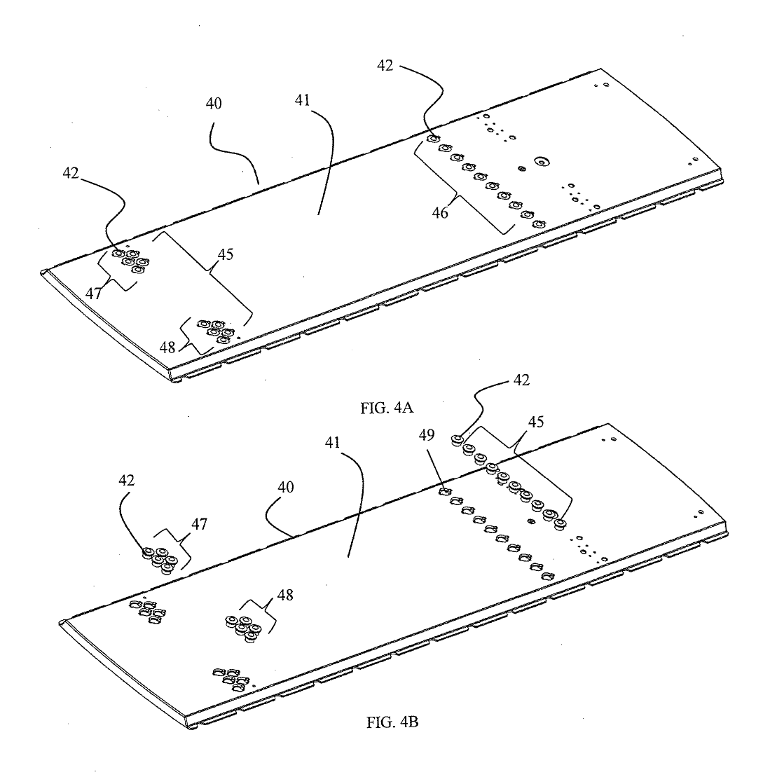

Another embodiment of the invention is shown in FIGS. 4A and 4B. The patient transfer device 40 has both a superior set 45 of rollers 42 and an inferior set 46 of rollers 42. The rollers 42 may be coupled to the device 40, attached to the device 40, embedded in the device 40, etc., via the bottom surface 41 of the patient transfer device 40. The superior set 45 of rollers 42 are arranged such that a first group 47 of rollers 42 are positioned to the left of a patient's head and a second group 48 of rollers 42 are positioned to the right of the patients head. The inferior set 46 of rollers 42 are positioned so that they are inferior to a patient's torso. The sets 45, 46 and groups 47, 48 of rollers 42 may be advantageously arranged and positioned substantially outside of the treatment area and/or imaging area of the patient to reduce interference from the rollers 42 with the treatment and/or imaging.

FIG. 4B shows an exploded view of the patient transfer device 40. Recesses 49 are formed on the bottom surface 41 of the patient transfer device 40 and are configured to receive the rollers 42. The recesses 49 may extend to a depth past the bottom surface 41 of the patient transfer device 40 such that the rollers 42 are embedded into the patient transfer device 40 when inserted in the recesses 49. Although the rollers 42 are depicted coupled to the patient transfer device 40 via the recesses 49, the rollers 42 may be coupled to the patient transfer device 40 in alternative ways. For example, the rollers 42 may be affixed to the bottom surface 41, adhered to the bottom surface 41, formed on the bottom surface 41, and/or other ways of coupling without the use of recesses (e.g., recesses 49) as will be understood by one of skill in the art from the disclosure herein.

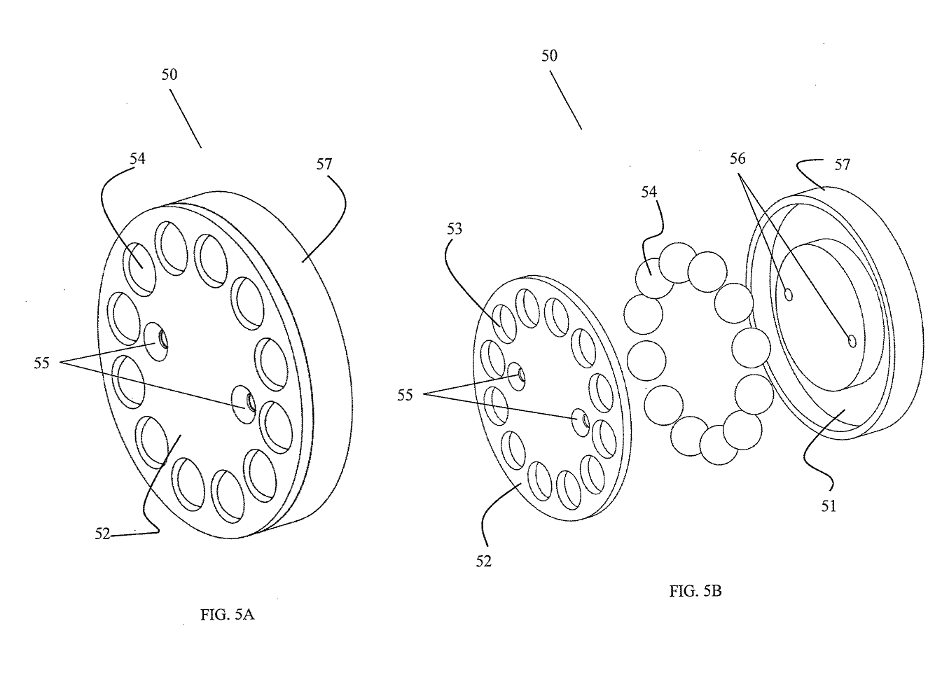

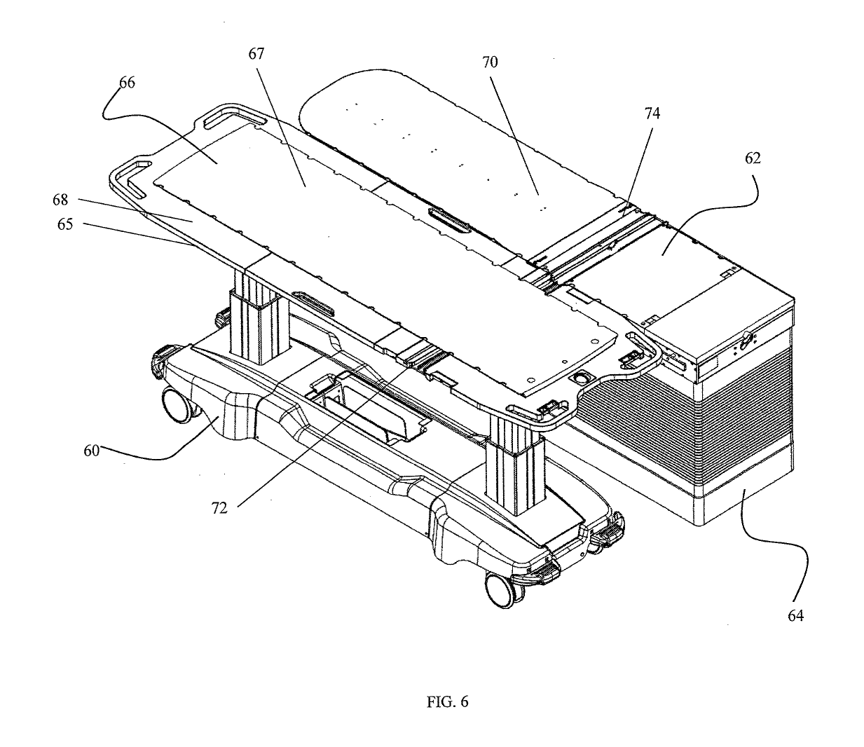

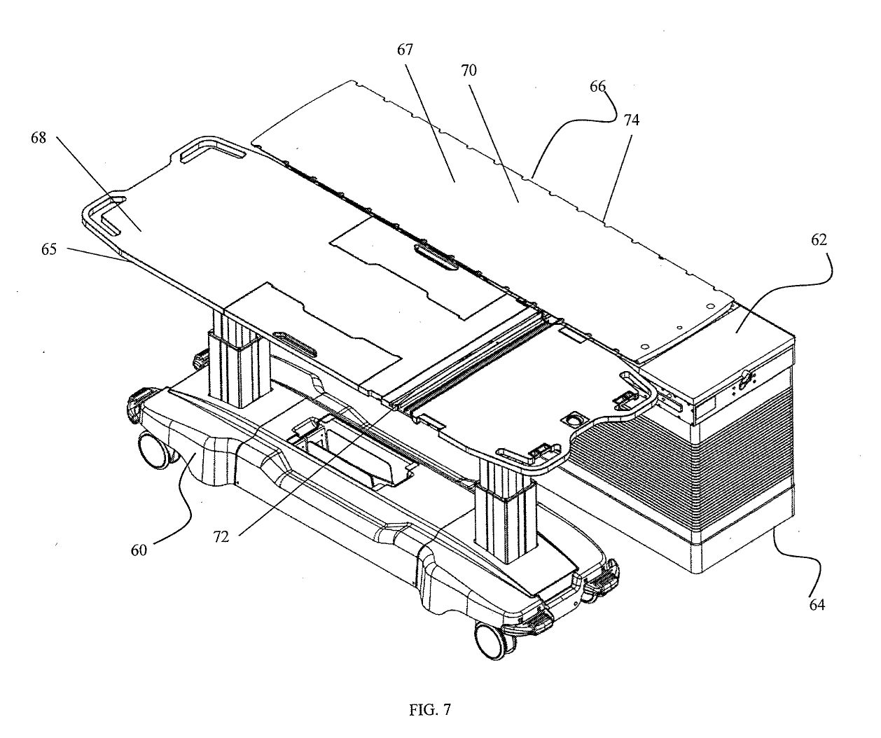

FIGS. 5A and 5B show an embodiment of a roller to be used in the invention. The roller 50 contains a bottom plate 57 which contains a pocket 51. There is also top plate 52 which contains circular holes 53. Between the plates is at least one ball 54. These balls sit in the pocket 51 and protrude through the circular holes 53. This roller 50 can be coupled (e.g., embedded, attached, adhered, mounted via mounting holes 55 and 56 (e.g., via screws), etc.) in either the stationary surface of a modality (e.g., modality 4) or a patient transfer device (e.g., patient transfer devices 2, 30, 40). The design of these rollers 50 allows a low friction interface to be created and at the same time minimize the gap between the surfaces of the modality and the patient transfer device. FIGS. 6 and 7 illustrate how the present invention would be used in a clinical setting. The trolley 60 is positioned adjacent to the treatment couch 64. The patient transfer device 66 rests above the top surface 68 of the stationary surface 65 of the trolley 60. The couch top 62 on the treatment couch 64 includes a top surface 70 and a guide track 74. The treatment couch 64 is designed to accept the patient transfer device 66 via the guide track 74 of the couch top 62 and the guide track 72 of the trolley 60, as well as rollers positioned between the patient support device 66 and the stationary surface 65 of the trolley 60. Particular aspects of the guide tracks 72 and 74, as well as additional features relating to the trolley 60 and treatment couch 64 can be found in related U.S. patent application Ser. No. 14/044,395, the contents of which are incorporated by reference herein.

As shown in FIG. 7 the patient transfer device 66 can be transferred to the couch top 62 from the stationary surface 65 of the trolley 60. The patient transfer device 66 may be moved, relative to the stationary surface 65 of the trolley 60, between the stationary surface of the trolley 60 and the couch top 52 of the treatment couch 64. In one embodiment, the patient support surface 66 is moved transversely with respect to the trolley 60 between the stationary surface 65 and the couch top 62.

The patient transfer device 66 may be moved between modalities (e.g., the trolley 60 and the treatment couch 64) as disclosed herein. First, a patient transfer device is placed on a stationary surface of a modality. In one embodiment, the patient transfer device is configured to support a patient. A patient is then positioned on a top surface of the patient transfer device.

Next, the stationary surface of the modality is aligned to a surface of another modality. In one embodiment, the stationary surface is on a trolley, and the trolley is moved next to another modality (e.g., a treatment couch) to align the stationary surface with the treatment couch. In an embodiment, the stationary surface and the other modality are aligned by aligning guide tracks formed on the stationary surface and/or the other modality.

The patient transfer device is then transferred between the modalities with the patient supported by the patient transfer device. In an embodiment, the patient transfer device is transferred between a trolley and a treatment couch. The patient transfer device may be transferred along at least one roller associated with the patient transfer device. The at least one roller facilitates movement of the patient transfer device between the modalities. The at least one roller may be attached, coupled, embedded, mounted, adhered, etc., to the patient transfer device. While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A system for transporting a patient between modalities, the system comprising:
a treatment couch having a couch top;
a trolley having a stationary surface;
a patient transfer device having a surface configured to support a patient; and
at least one roller positioned to facilitate movement of the patient transfer device with respect to the stationary surface of the trolley, thereby providing a low friction interface between the patient transfer device and the stationary surface of the trolley as the patient transfer device is moved, relative to the stationary surface of the trolley, between the stationary surface of the trolley and the couch top of the treatment couch.

2. The system of claim 1, wherein the at least one roller is associated with the patient transfer device.

3. The system of claim 1, wherein the patient transfer device and the at least one roller are constructed of MRI compatible materials.

4. The system of claim 1, the treatment couch having a treatment area within which treatment of the patient is conducted, wherein the at least one roller is positioned outside of the treatment area of the treatment couch when the patient transfer device is positioned on the couch top of the treatment couch.

5. The system of claim 1, wherein the at least one roller comprises a set of superior rollers and a set of inferior rollers.

6. The system of claim 5, wherein the set of superior rollers comprises a first group of rollers positioned to one side of a head of the patient and a second group of rollers positioned to another side of the head of the patient.

7. The system of claim 5, wherein the inferior set of rollers are positioned interior to a position of a torso of the patient.

8. The system of claim 1, wherein the at least one roller comprises at least one of a cylindrical roller, a spherical roller, an elliptical roller, or a conical roller.

9. A patient transfer device configured for transporting a patient between surfaces of modalities, the patient transfer device comprising:
a top surface and a bottom surface, the top surface being configured to support a patient; and
at least one roller associated with the bottom surface of the patient transfer device, the at least one roller being positioned to facilitate movement of the patient transfer device with respect to a stationary surface of one modality, thereby providing a reduced friction interface between the patient transfer device and the stationary surface of the one modality as the patient transfer device is moved, relative to the stationary surface of one modality, between the stationary surface of the one modality and a surface of another modality.

10. The device of claim 9, wherein the at least one roller is embedded in the bottom surface of the patient transfer device.

11. The device of claim 9, wherein the at least one roller protrudes less than 1 cm from the bottom surface of the patient transfer device.

12. The device of claim 9, the modalities each having a treatment area within which treatment of the patient is conducted, wherein the at least one roller is positioned outside of the treatment areas of the modalities.

13. The device of claim 9, wherein the at least one roller is constructed of a ceramic-based material.

14. The device of claim 9, wherein the at least one roller is constructed of a metallic material.

15. The device of claim 9, wherein the at least one roller is positioned to facilitate movement of the patient transfer device between the stationary surface of a trolley and a couch top of a imaging and/or treatment couch in a direction that is substantially transverse with respect to the stationary surface.

16. The device of claim 9, wherein the at least one roller is positioned to facilitate movement of the patient transfer device without movement of the patient supported by the top surface of the patient transfer device relative to the top surface of the patient transfer device.

17. A method for transporting a patient between modalities, comprising:
placing a patient transfer device on a stationary surface of one modality;
positioning a patient on a top surface of the patient transfer device;
aligning the stationary surface of the one modality to a surface of another modality; and
transferring the patient transfer device with the patient on the top surface between the stationary surface of the one modality and the surface of the another modality along at least one roller associated with the patient transfer device, the at least one roller facilitating movement of the patient transfer device between the stationary surface of the one modality and the surface of the another modality.

18. The method of claim 17, wherein the one modality is a trolley and the another modality is an imaging and/or treatment couch, and wherein the transferring step includes transferring the patient transfer device with the patient on the top surface between the stationary surface of the trolley and the couch top of the imaging and/or treatment couch along the at least one roller associated with the patient transfer device.

19. The method of claim 18, wherein the imaging and/or treatment couch has a treatment area within which treatment of the patient is conducted, the method further comprising positioning the patient transfer device on the treatment couch such that the at least one roller is positioned outside of the treatment area of the treatment couch.

20. The method of claim 17, wherein the at least one roller comprises a set of superior rollers in one location and a set of inferior rollers in another location, and wherein the transferring step includes transferring the patient transfer device along the set of superior rollers and the set of inferior rollers.

21. A patient transfer system consisting of;
a patient surface;
a lower surface;
at least one roller separating the patient surface and the lower surface.

22. The system as claimed in claim 21 wherein the roller provides a low friction interface between the patient surface and the lower surface.

23. The system as claimed in claim 21 wherein the roller is at least one of cylindrical, spherical, elliptical, or conical.

24. The system as claimed in claim 21 wherein the roller is MRI compatible.

25. The system as claimed in claim 21 wherein the roller is comprised of any of ceramic, wood, aluminum, stainless steel, plastic, steel, magnesium, stone, titanium, and copper.

26. The system as claimed in claim 21 wherein the roller is located to maximize imaging area.

27. The system as claimed in claim 21 wherein the roller is mounted to the patient surface.

28. The system as claimed in claim 21 wherein the roller is mounted to the lower surface.

29. The system as claimed in claim 21 wherein the roller is retractable.

30. The system as claimed in claim 21 wherein the roller is a fixed height.

31. The system as claimed in claim 21 wherein the roller is removable.

32. The system as claimed in claim 21 wherein the roller is permanently mounted.

33. The system as claimed in claim 21 wherein the roller is able to be relocated.

34. The system height roller of claim 30 wherein the distance between the patient surface and the lower surface is less than 0.5 cm.

35. The system as claimed in claim 33 wherein the position of the roller is adaptable to different treatment plans.

36. The system as claimed in claim 21 wherein the roller is replaceable.

37. A roller for transferring patients consisting of;
A bottom plate containing a pocket;
A top plate which contains at least one circular cutout;
At least one circular roller which is encapsulated between the bottom plate and top plate and protrudes through the at least one cutout of the top plate.

38. A method for moving patients from one target modality to another using the system as claimed in claim 21.
